(19) United States
(12) Patent Application Publication
(10) Pub. No.: US 2011/0077993 A1
(43) Pub. Date: Mar. 31, 2011

(54) REMOTE MANAGED SERVICES IN MARKETPLACE ENVIRONMENT

(75) Inventors: Anca Sailer, Scarsdale, NY (US); Hidayatulla H. Shaikh, Shrub Oak, NY (US); Dennis G. Shea, Ridgefield, CT (US); Yang Song, Kirkland, WA (US); Mahesh Viswanathan, Yorktown Heights, NY (US)

(73) Assignee: INTERNATIONAL BUSINESS MACHINES CORPORATION, Armonk, NY (US)

(21) Appl. No.: 12/568,079

(22) Filed: Sep. 28, 2009

(51) Int. Cl. G06Q 10/00; G06F 17/30

(52) U.S. Cl. 705/9; 707/E17.044

(57) ABSTRACT

Registration of a plurality of customers, each having an information technology infrastructure, with a manager of remote services is facilitated. Registration of a plurality of service partners with the manager is also facilitated. The manager detects an issue with a given one of the information technology infrastructures of a given one of the customers. Responsive to the detecting, responses from a subset of the service partners for potential selection to address the issue are facilitated. The partners in the subset are ranked based at least in part on ratings of the service partners in a rating database. A top-ranked one of the service partners is assigned to address the issue.

### FIELD OF THE INVENTION

The present invention relates to the electrical and electronic arts, and, more particularly, to information technology (IT) and the like.

### BACKGROUND OF THE INVENTION

Service-oriented architecture (SOA) provides a set of principles used during systems development and integration. Functionality is provided as interoperable services; for example, software modules provided as a service can be used by several entities, even if their respective client systems are substantially different. An implementation of SOA is denoted a service oriented architecture implementation. Instead of defining an application program interface (API), SOA defines the interface in terms of protocols and functionality. The entry point to such an SOA implementation is referred to as an endpoint.

Petrie et al., in “The Myth of Open Web Services: The Rise of the Service Parks,” IEEE Internet Computing May/June 2008, 80-82, describe service parks as revolutionary. The remote managed services market is a rapidly emerging market growing at a compound annual growth rate (CAGR) of 36%, and is projected to grow from $14.3 billion US to $30 billion US by 2010. Service providers use their own fixed network operations center to remotely monitor and manage clients' IT infrastructure elements such as networks, system hardware and software, operating systems and applications.

There are typically no fine granularity (e.g., management task level) options for the customer to select among multiple service providers, or for the service provider to select among multiple service sources. A service provider who integrates services from multiple sources typically makes a one-time decision as to what service source to leverage based on its features and/or functional capability at the time of the decision. Performance is measured against user-defined service level objectives for the service provider's customers. This approach has an overall high cost for the SMB (Small to Medium Business) market, where participants usually cannot afford the elevated cost of highly customized IT management offered by a specific service provider.

U.S. Pat. No. 7,065,496 of Subbloie et al. discloses a system for managing equipment, services and service provider agreements. The system includes a server, an agreements database accessible by the server, the agreements database having stored thereon contracted performance data indicative of minimum service performance required by at least one service provider agreement, a user preferences database accessible by the server, the preferences database having stored thereon user preference data indicative of a user specified maximum allowable deviance from the minimum service performance, a performance measurement module in communication with the server; the performance measurement module gathering actual performance data indicative of actual service performance and a variance calculator in communication with the server, the variance calculator determining agreement conformity status by determining whether the actual system performance indicated by the actual service performance data corresponds with the minimum service performance indicated by the contracted performance data within the maximum allowable deviance indicated by the user preference data.

### SUMMARY OF THE INVENTION

Principles of the present invention provide techniques for remote managed services in a marketplace environment. In one aspect, an exemplary method (which can be computer implemented) includes the steps of facilitating registration of a plurality of customers, each having an information technology infrastructure, with a manager of remote services; and facilitating registration of a plurality of service partners with the manager. The method further includes detecting, by the manager, of an issue with a given one of the information technology infrastructures of a given one of the customers; and, responsive to the detecting, facilitating responses from a subset of the service partners for potential selection to address the issue. Furthermore, additional steps include ranking the subset of the service partners based at least in part on ratings of the service partners in a rating database; and assigning a top-ranked one of the service partners to address the issue.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed.

One or more embodiments of the invention or elements thereof can be implemented in the form of a computer product including a computer readable storage medium with computer usable program code for performing the method steps indicated. Furthermore, one or more embodiments of the invention or elements thereof can be implemented in the form of an apparatus including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s), or (iii) a combination of hardware and software modules; any of (i)-(iii) implement the specific techniques set forth herein, and the software modules are stored in a computer readable storage medium (or multiple such media).

One or more embodiments of the invention may offer one or more of the following technical benefits:
allows managed services tasks on a market place to be used in real time: not necessarily based on business process execution language (BPEL), but rather vetted sources and offerings with ratings
cost reduction for infrastructure management for global enterprises and SMBs

These and other features, aspects and advantages of the present invention will become apparent from the following detailed description of illustrative embodiments thereof, which is to be read in connection with the accompanying drawings.

### BRIEF DESCRIPTION OF THE DRAWINGS

FIG. 1 shows a diagram of an exemplary remote managed services infrastructure in a market place environment and the related processes when providing a technical support service, according to an aspect of the invention;

FIG. 2 shows a diagram of an exemplary remote managed services infrastructure in a market place environment and examples of remote managed services from service delivery agents or business partners, according to another aspect of the invention;

FIG. 3 shows a flow chart of an exemplary method, according to yet another aspect of the invention; and

FIG. 4 depicts a computer system that may be useful in implementing one or more aspects and/or elements of the invention.

### DETAILED DESCRIPTION OF PREFERRED EMBODIMENTS

One significant value for remote managed services in a market place environment is that it helps global enterprises and SMBs to cut down costs for infrastructure management and to gain access to expert skills. One or more embodiments of the invention apply the concept of a marketplace for services to managed services tasks in real time.

Another significant benefit arises in the case where an entity has multiple services that perform the same or similar functions, which is both costly and redundant. Advantageously, in the marketplace approach, the ability is provided to allow the market to pick the best services, so that the redundancy can be eliminated.

Described herein are two non-limiting exemplary service models for remote managed services in a market place environment, as well as the related technologies, tools, processes and skills. In a first embodiment, the managed services provider: offers the infrastructure that allows the customers to subscribe to remote monitoring and managed services, and the service delivery agents and business partners to join the managed services market; makes the decision on the most appropriate service delivery agent or business partner enlisted as joining the market; bills the customer for the service; pays the service delivery agents and business partners for the service provided to the customer; and keeps and updates private records of the customers' feedback on the recommended agent or business partner.

In a second embodiment, the managed services provider: offers the infrastructure that allows the customers to subscribe to remote monitoring and managed services, and the service delivery agents and business partners to join the managed services market; bills the customer for the service; and bills service delivery agents and business partners for advertising them on the market place. In this second embodiment, the client decides on and pays the most appropriate service delivery agent or business partner enlisted as joining the market based on public reviews about the agent or partner.

Significant advantages of one or more embodiments include, as noted: (1) allows managed services tasks on a market place to be used in real time: not necessarily based on business process execution language (BPEL), but rather vetted sources and offerings with ratings; and (2) cost reduction for infrastructure management for global enterprises and SMBs.

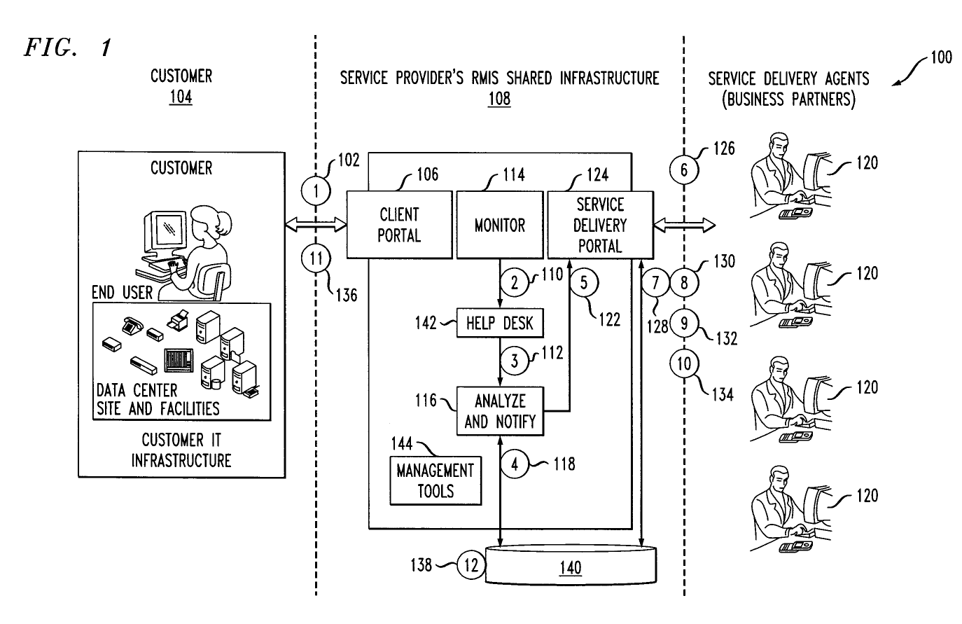

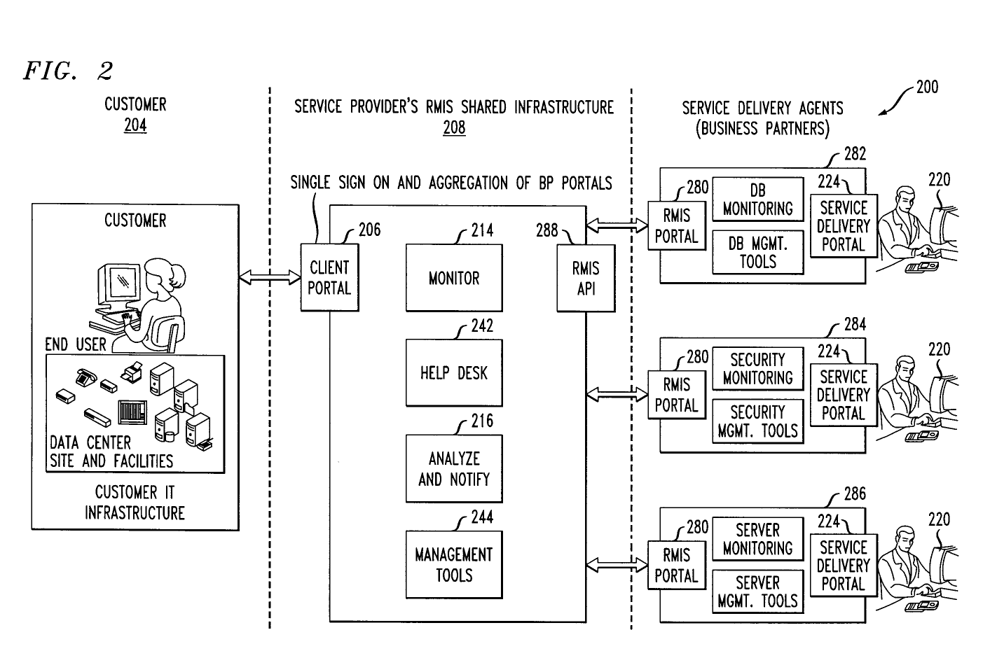

FIG. 1 shows a diagram of a remote managed services infrastructure 100 in a market place environment. Each item, and the flow of information between the items during the operational phase of a technical support service provisioning, are described below. Those skilled in the art will appreciate, however, that the technical support service provisioning example is a non-limiting example, and any other desired service can be provided by service delivery agents or business partners without altering the exemplary service model for remote managed services in a market place environment, as will be seen in connection with diagram 200 of FIG. 2. Examples of remote managed services include, but are not limited to, desktop management, server management, applications management, middleware management, databases management, network management, security management, and the like. In addition, the interaction between the RMIS (remote managed infrastructure services) service provider and the service delivery agents or business partners can be carried out at the people and/or skills level, as well as at the programmatic level.

A first non-limiting exemplary model will now be described. In a first process 102 the customer 104 signs-up via a client portal 106 for RMIS with a service provider, and is “on-boarded.” The service provider's RMIS shared infrastructure is depicted at 108. In a second process 110, a ticket is raised (with help desk 142) for a threshold breach detected during steady-state monitoring by monitor module 114. In a third process 112, analysis sub-system 116 is called. In a fourth process 118, the RMIS service provider selects a sub-set of the service delivery agents or business partners 120 to fix the problem based on a suitable analysis taking into account, by way of example and not limitation:

Time of the day (follow the sun)

Skills

Wages

History & rating of past experiences

This is a general linear optimization problem and can be solved very efficiently in linear time. Details of one suitable non-limiting exemplary technique are provided below.

In a fifth process 122, the selected service delivery agents or business partners are notified via service delivery portal 124. In a sixth process 126, the interested service delivery agents or business partners respond (optionally, with a quote). In a seventh process 128, the service delivery agents or business partners who responded to the request are ranked using the analysis sub-system 116 (and optionally taking into consideration the quote, as well). In an eighth process 130, the top service delivery agent or business partner on the list is assigned the ticket.

In a ninth process 132, the service delivery agent or business partner fixes the problem, leveraging relevant data, access, processes, and the like provided by the shared RMIS infrastructure 108. The service delivery agent's or business partner's processes are checked at well-established check-points, especially when the process involves a context switch from or to the service delivery agent's or business partner's processes to or from, respectively, the RMIS service provider's processes. These check-points help separate, in the overall customer's evaluation of the received service, the evaluation related to the service delivery agents or business partner from the evaluation related to the RMIS service provider.

In a tenth process 134, the service delivery agent's or business partner's Incident Problem Change (IPC) counter gets increased by 1. Party 120 is paid at the end of an appropriate billing cycle. In an eleventh process 136, the customer 104 rates how well the service was performed (e.g., how quickly and effectively the issue was fixed). In a twelfth process 138, the feeds from the eleventh process are used to update a database (DB) 140; in this case, a private evaluation database (which is then used in the fourth and seventh processes 118, 128).

In this first non-limiting exemplary model, the customer 104 pays the RMIS service provider a monthly fee for the monitoring and services received, while the RMIS service provider pays the service delivery agents or business partners 120 for the services provided making it transparent to the customer. The management tools 144 can be provided by the RMIS provider for service management tasks such as configuration management, release management, change management, incident management, problem management, capacity management, service level management, availability management, service desk, and the like.

A second non-limiting exemplary model will now be described. In first process 102, the customer 104 signs-up via the client portal 106 for RMIS with a service provider and is “on-boarded.” In second process 110, a ticket is raised for a threshold breach detected during steady-state monitoring. In third process 112, the customer is notified on the problem that occurred. In fourth process 118, the customer selects a sub-set of service delivery agents or business partners to fix the problem based on, by way of example and not limitation:

Time of the day (follow the sun)

Skills

Wages

History & rating of past experiences

In fifth process 122, the selected service delivery agents or business partners are notified via the service delivery portal 124. In sixth process 126, the interested service delivery agents or business partners respond (with or without a quote). In seventh process 128, the service delivery agents or business partners who responded to the request are ranked using the analysis sub-system 116 (and optionally taking into consideration the quote, as well). In eighth process 130, the ‘top’ service delivery agent or business partner on the list is assigned the ticket. In ninth process 132, the service delivery agent or business partner fixes the problem, leveraging relevant data, access, processes, and the like provided by the shared RMIS infrastructure 108.

In tenth process 134, the service delivery agents or business partner's IPC counter gets increased by 1. In eleventh process 136, the customer rates how well the service was performed (e.g., how quickly and effectively the problem was fixed). In twelfth process 138, the feeds from the eleventh process are used to update a database 140, which in this case is a public evaluation DB (which is then used in the fourth and seventh processes 118, 128).

In this second non-limiting exemplary model, the customer pays the RMIS service provider a monthly fee for the monitoring services received and also pays the service delivery agents or business partners for their services. The service delivery agents or business partners pay the RMIS service provider for the RMIS leverage and advertisement in the market place.

Note that customer 104 typically has one or more end users as well as an IT infrastructure which may include, for example, one or more data center sites with IT resources including managed servers, bridges, routers, printers, voice over internet protocol (VoIP) components, switches, storage, endpoint agents including ITM (IBM Tivoli® Monitoring software—registered mark of International Business Machines Corp., Armonk, N.Y., USA) and/or ESA (Electronic Service Agent), and the like. These items are not separately numbered in FIGS. 1 and 2, to avoid clutter. Note that IBM Tivoli® Monitoring software is a non-limiting example of system monitoring software to manage operating systems, databases and servers in distributed and host environments.

FIG. 2 will now be described. Elements therein similar to those in FIG. 1 have received the same reference character incremented by one hundred, and are not necessarily described again. As seen in FIG. 2, client portal 206 of infrastructure 208 provides single sign-on and aggregation of business partner portals. RMIS application program interface (API) 288 of infrastructure 208 is exposed to RMIS portals 280 of agents or partners 220. Entities 220 interface with service delivery portals 224 for delivery of, for example, database monitoring and management service 282, security monitoring and management service 284, and/or server monitoring and management service 286. Other services can also be provided.

Non-limiting exemplary selection optimization techniques will now be described. A suitable optimization technique may be applied for candidate selection. Specifically, in one or more embodiments, maximize the profit by choosing the best candidate, which candidate minimizes the cost of solving the ticket, subject to availability and ratings. Formally, given a ticket and/or problem A and a set of M candidate BP_{S} {BP₁, BP₂, . . . BP_{M}}, one can pull out their corresponding attributes as follows:
(1) Time of the Day {T₁, T₂, . . . , T_{M}}, where each Tᵢ corresponds to the time of the i^{th} BP, which may be represented using binary encoding, for example, available (Tᵢ=1) and not available (Tᵢ=−1).
(2) Ratings {R₁, R₂, . . . R_{M}}, where each Rᵢ denotes the ratings of the i^{th} BP for the ticket and/or problem A (Since each BP may declare multiple interests or skills for solving different problems, one may want to give separate ratings for different categories of problems for each BP). The ratings can either be a numerical positive value with a fixed scale (e.g., Rᵢ=[1, 10]), or a free number without bound that changes according to the feedback of the customers.
(3) Wages {W₁, W₂, . . . W_{M}}, where each Wᵢ shows the fixed wage or bidding price for BPᵢ of the ticket A.
(4) Response Times {RT₁, RT₂, . . . RT_{M}} where each RTᵢ denotes the time it took for the BPᵢ to solve the problem A.

Given these attributes, the only parameter that affects the decision of choosing the best BP is the threshold of the ratings. Given a cut-off rating R*, the mathematical formation of the optimization problem can be written as follows:

$$\begin{matrix}select & {BP}_{m} = arg {min}_{m} ( {W}_{m} ) \\ subject to & {R}_{m} \geq R * , {RT}_{m} \leq RT * , {T}_{m} \geq 0 , m = 1 , . . . M\end{matrix} \qquad ( 1 )$$

The examples cited above are examples of possible attributes over which the selection technique may be optimized.

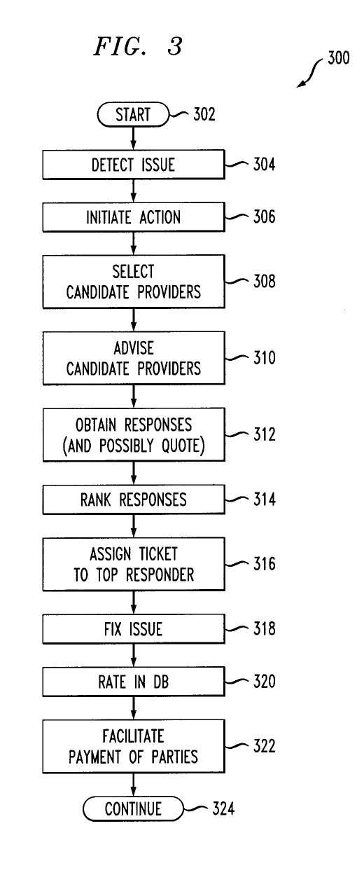

Reference should now be had to flow chart 300 of FIG. 3, wherein processing begins at step 302. Given the description thus far, it will be appreciated that, in general terms, an exemplary method, according to an aspect of the invention, includes the steps of facilitating registration of a plurality of customers 104, each having an information technology infrastructure, with a manager of remote services (e.g., having shared infrastructure 108), as well as facilitating registration of a plurality of service partners 120 with the manager. Client and service delivery portals 106, 124, respectively may be used, for example, to implement these steps. An additional step 304 includes detecting, by the manager, of an issue with a given one of the information technology infrastructures of a given one of the customers (for example, with monitoring module 114). An additional step, in response to detection of the issue, includes facilitating responses from a subset of the service partners for potential selection to address the issue, as will be discussed further below. This general step may include, for example, initiating an action in step 306, selecting candidate providers in step 308, advising the selected providers in step 310, and obtaining responses, and possibly quotes, from the selected providers, in step 312.

Step 314 includes ranking (for example, with analysis module 116) the subset of the service partners based at least in part on ratings of the service partners in a rating database 140. Step 316 includes assigning the top-ranked one of the service partners to address the issue.

In some instances (for example, the first exemplary model discussed above), the aforementioned step of facilitating the responses can be carried out as follows. In step 306, the action initiated includes calling, by the manager, analysis system 116. Step 308 includes picking, with the analysis system, the subset of the service partners, based at least in part on the database 140. Step 310 includes the manager advising the subset of the service partners of the picking (for example, via portal 124). Step 312 includes the manager receiving the responses in response to the advising step (again, for example, via portal 124). In at least some cases, the responses include monetary quotes and the ranking 314 is further based on the monetary quotes. Furthermore, in this example, the rating database 140 can be a private database.

Optional additional steps include facilitating the top-ranked one of the service partners addressing the issue, as at 318, and storing, in the rating database 140, a rating, from the given one of the customers, of performance of the top-ranked one of the service partners in addressing the issue. Optional additional step 322 includes facilitating payment of parties; for example, the customers paying the manager a periodic fee, and the manager paying the service partners for services provided to the customers.

Processing continues at block 324.

In one or more embodiments, the picking of the subset 308 and the ranking of the subset 314 are carried out via linear optimization based at least on the ratings and cost data. The final selection 314 may, for example, be in accordance with the relationships (1).

In some instances (for example, the second exemplary model discussed above), the aforementioned step of facilitating the responses can be carried out as follows. Step 306 includes the manager advising the given one of the customers of the issue (for example, via client portal 106). Step 308 includes facilitating picking, by the given one of the customers, the subset of the service partners relevant to the customer's needs. The selection is performed by analysis in the module 116, based at least in part on a database similar to 140 which contains the service evaluations received via the portal 106. Step 310, in this embodiment, includes the customer directly contacting the selected partners via the portal 106 linked into the portal 124. Step 312 includes the manager receiving the responses in response to the advising step; for example, via portal 124. In at least some cases, the responses include monetary quotes and the ranking 314 is further based on the monetary quotes. Furthermore, in this example, the rating database 140 can be a public database.

Optional additional steps include facilitating the top-ranked one of the service partners addressing the issue, as at 318, and storing, in the rating database 140, a rating, from the given one of the customers, of performance of the top-ranked one of the service partners in addressing the issue. Optional additional step 322 includes facilitating payment of parties; for example, the customers paying the manager a periodic fee, and the customers paying the service partners for services provided to the customers.

In one or more embodiments, the picking of the ranking of the subset 314 is carried out via linear optimization based at least on the ratings and cost data; for example, in accordance with the relationships (1). Similar rating techniques can be employed in the second model as are employed in the first model.

### Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

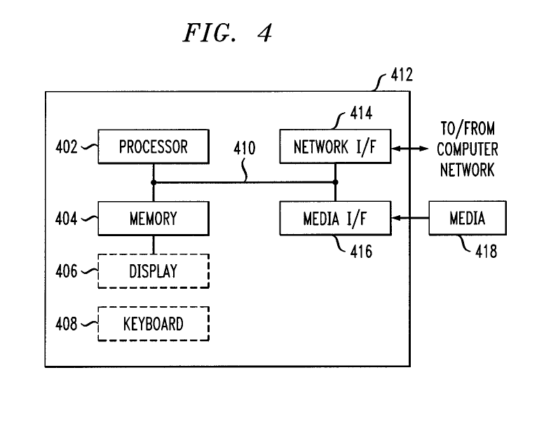

One or more embodiments can make use of software running on a general purpose computer or workstation. With reference to FIG. 4, such an implementation might employ, for example, a processor 402, a memory 404, and an input/output interface formed, for example, by a display 406 and a keyboard 408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 402, memory 404, and input/output interface such as display 406 and keyboard 408 can be interconnected, for example, via bus 410 as part of a data processing unit 412. Suitable interconnections, for example via bus 410, can also be provided to a network interface 414, such as a network card, which can be provided to interface with a computer network, and to a media interface 416, such as a diskette or CD-ROM drive, which can be provided to interface with media 418.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 402 coupled directly or indirectly to memory elements 404 through a system bus 410. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 408, displays 406, pointing devices, and the like) can be coupled to the system either directly (such as via bus 410) or through intervening I/O controllers (omitted for clarity).

Network adapters such as network interface 414 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 412 as shown in FIG. 4) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 418 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams of FIGS. 1 and 2; by way of example and not limitation, a client portal module, a service delivery portal module, a monitoring module, and an analysis module. The method steps can then be carried out using the distinct software modules and/or sub-modules of the system, as described above, executing on one or more hardware processors 402. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising the steps of
facilitating registration of a plurality of customers, each having an information technology infrastructure, with a manager of remote services;
facilitating registration of a plurality of service partners with said manager;
detecting, by said manager, of an issue with a given one of said information technology infrastructures of a given one of said customers;
responsive to said detecting, facilitating responses from a subset of said service partners for potential selection to address said issue;
ranking said subset of said service partners based at least in part on ratings of said service partners in a rating database; and
assigning a top-ranked one of said service partners to address said issue.

2. The method of claim 1, wherein:
said step of facilitating said responses comprises:
calling, by said manager, an analysis system;
picking, with said analysis system, said subset of said service partners, based at least in part on said database;
said manager advising said subset of said service partners of said picking; and
said manager receiving said responses in response to said advising step.

3. The method of claim 2, wherein said responses include monetary quotes and wherein said ranking is further based on said monetary quotes.

4. The method of claim 2, wherein said rating database is a private database, further comprising:
facilitating said top-ranked one of said service partners addressing said issue; and
storing, in said rating database, a rating, from said given one of said customers, of performance of said top-ranked one of said service partners in addressing said issue.

5. The method of claim 4, further comprising:
said customers paying said manager a periodic fee; and
said manager paying said service partners for services provided to said customers.

6. The method of claim 2, wherein said picking of said subset and said ranking of said subset comprise linear optimization based at least on said ratings and cost data.

7. The method of claim 1, wherein:
said step of facilitating said responses comprises:
said manager advising said given one of said customers of said issue;
facilitating picking, by said given one of said customers, said subset of said service partners, based at least in part on said database;
said given one of said customers advising said subset of said service partners of said picking; and
said manager receiving said responses in response to said advising step.

8. The method of claim 7, wherein said responses include monetary quotes and wherein said ranking is further based on said monetary quotes.

9. The method of claim 7, wherein said rating database is a public database, further comprising:
facilitating said top-ranked one of said service partners addressing said issue; and
storing, in said rating database, a rating, from said given one of said customers, of performance of said top-ranked one of said service partners in addressing said issue.

10. The method of claim 9, further comprising:
said customers paying said manager a periodic fee; and
said customers paying said service partners for services provided to said customers.

11. The method of claim 7, wherein said ranking of said subset comprise linear optimization based at least on said ratings and cost data.

12. The method of claim 1, further comprising providing a system, wherein the system comprises distinct software modules, each of the distinct software modules being embodied on a computer-readable storage medium, and wherein the distinct software modules comprise a client portal module, a service delivery portal module, a monitoring module, and an analysis module;
wherein:
said facilitating registration of said plurality of customers is carried out by said client portal module executing on at least one hardware processor;
said facilitating registration of said plurality of service partners is carried out by said service delivery module executing on said at least one hardware processor;
said detecting, by said manager, of said issue is carried out by said monitoring module executing on said at least one hardware processor;
said facilitating of said responses is carried out by said service delivery portal module executing on said at least one hardware processor; and
said ranking of said subset is carried out by said analysis module executing on said at least one hardware processor.

13. A computer program product comprising a computer readable storage medium having computer readable program code embodied therewith, said computer readable program code comprising:
computer readable program code configured to facilitate registration of a plurality of customers, each having an information technology infrastructure, with a manager of remote services;
computer readable program code configured to facilitate registration of a plurality of service partners with said manager;
computer readable program code configured to detect, by said manager, an issue with a given one of said information technology infrastructures of a given one of said customers;
computer readable program code configured to, responsive to said detecting, facilitate responses from a subset of said service partners for potential selection to address said issue;
computer readable program code configured to rank said subset of said service partners based at least in part on ratings of said service partners in a rating database; and
computer readable program code configured to facilitate assigning a top-ranked one of said service partners to address said issue.

14. The computer program product of claim 13, wherein:
said computer readable program code configured to facilitate said responses comprises:
computer readable program code configured to call, by said manager, an analysis system;
computer readable program code configured to pick, with said analysis system, said subset of said service partners, based at least in part on said database;
computer readable program code configured to advise, by said manager, said subset of said service partners of said picking; and
computer readable program code configured to receive, by said manager, said responses in response to said advising step.

15. The computer program product of claim 14, wherein said rating database is a private database, further comprising computer readable program code configured to store, in said rating database, a rating, from said given one of said customers, of performance of said top-ranked one of said service partners in addressing said issue.

16. The computer program product of claim 14, wherein said computer readable program code configured to pick said subset and said computer readable program code configured to rank said subset comprises computer readable program code configured to carry out linear optimization based at least on said ratings and cost data.

17. The computer program product of claim 13, wherein:
said computer readable program code configured to facilitate said responses comprises:
computer readable program code configured to advise, by said manager, said given one of said customers of said issue;
computer readable program code configured to facilitate picking, by said given one of said customers, said subset of said service partners, based at least in part on said database;
computer readable program code configured to advise said subset of said service partners of said picking, by said given one of said customers; and
computer readable program code configured to receive, by said manager, said responses in response to said advising step.

18. The computer program product of claim 17, wherein said rating database is a public database, further comprising computer readable program code configured to store, in said rating database, a rating, from said given one of said customers, of performance of said top-ranked one of said service partners in addressing said issue.

19. An apparatus comprising:
a memory; and
at least one processor, coupled to said memory, and operative to:
facilitate registration of a plurality of customers, each having an information technology infrastructure, with a manager of remote services;
facilitate registration of a plurality of service partners with said manager;
detect, by said manager, an issue with a given one of said information technology infrastructures of a given one of said customers;
responsive to said detecting, facilitate responses from a subset of said service partners for potential selection to address said issue;
rank said subset of said service partners based at least in part on ratings of said service partners in a rating database; and
facilitate assigning a top-ranked one of said service partners to address said issue.

20. The apparatus of claim 19, wherein said at least one processor is operative to facilitate said responses by:
calling, by said manager, an analysis system;
picking, with said analysis system, said subset of said service partners, based at least in part on said database;
advising, by said manager, said subset of said service partners of said picking; and
receiving, by said manager, said responses in response to said advising step.

21. The apparatus of claim 20, wherein said rating database is a private database, and wherein said at least one processor is further operative to store, in said rating database, a rating, from said given one of said customers, of performance of said top-ranked one of said service partners in addressing said issue.

22. The apparatus of claim 20, wherein said at least one processor is operative to pick said subset and to rank said subset by carrying out linear optimization based at least on said ratings and cost data.

23. The apparatus of claim 19, wherein:
said at least one processor is operative to facilitate said responses by:
advising, by said manager, said given one of said customers of said issue;
picking, by said given one of said customers, said subset of said service partners, based at least in part on said database;
advising said subset of said service partners of said picking, by said given one of said customers; and
receiving, by said manager, said responses in response to said advising step;
said rating database is a public database; and
said at least one processor is further operative to store, in said rating database, a rating, from said given one of said customers, of performance of said top-ranked one of said service partners in addressing said issue.

24. The apparatus of claim 19, further comprising a plurality of distinct software modules, each of the distinct software modules being embodied on a computer-readable storage medium, and wherein the distinct software modules comprise a client portal module, a service delivery portal module, a monitoring module, and an analysis module;
wherein:
said at least one processor is operative to facilitate registration of said plurality of customers by executing said client portal module;
said at least one processor is operative to facilitate registration of said plurality of service partners by executing said service delivery module;
said at least one processor is operative to detect, by said manager, said issue by executing said monitoring module;
said at least one processor is operative to facilitate said responses by executing said service delivery portal module; and
said at least one processor is operative to rank said subset by executing said analysis module.

25. An apparatus comprising:
means for facilitating registration of a plurality of customers, each having an information technology infrastructure, with a manager of remote services;
means for facilitating registration of a plurality of service partners with said manager;
means for detecting, by said manager, of an issue with a given one of said information technology infrastructures of a given one of said customers;
means for, responsive to said detecting, facilitating responses from a subset of said service partners for potential selection to address said issue;
means for ranking said subset of said service partners based at least in part on ratings of said service partners in a rating database; and
means for assigning a top-ranked one of said service partners to address said issue.
